(19) United States
(12) Patent Application Publication
(10) Pub. No.: US 2015/0136546 A1
(43) Pub. Date: May 21, 2015

(54) BRAKE DISC COMPRISING HETEROGENEOUS MATERIALS AND METHOD FOR MANUFACTURING THE SAME

(71) Applicants: Hyundai Motor Company, Seoul (KR); Kia Motors Corporation, Seoul (KR); Seohan Industry Co., Ltd., Choongchungbok-do (KR)

(72) Inventors: Yoon-Cheol Kim, Suwon (KR); Jai-Min Han, Suwon (KR); Seong-Jin Kim, Sungnam (KR); Jae-Young Lee, Yongin (KR); Kyoung-Don Yi, Daegu (KR)

(21) Appl. No.: 14/508,309

(22) Filed: Oct. 7, 2014

(30) Foreign Application Priority Data
Nov. 18, 2013 (KR) 10-2013-0139775

(51) Int. Cl. F16D 65/12; B22D 21/00; B22D 19/00

(52) U.S. Cl. CPC F16D 65/125; B22D 19/0081; B22D 19/00; B22D 21/007; F16D 2065/1304
USPC 188/218 XL; 164/103

(57) ABSTRACT

Disclosed is a brake disc manufactured from heterogeneous materials and a method for manufacturing the brake disc. The brake disc includes a friction part in which a connection hole is formed in a center, protrusions and recesses are alternately repeated along a circumference of the connection hole, the recess has a shape curved in an opposite direction of the connection hole. The brake disc also includes a hat part that is made of material different from that of the friction part, and has insertion grooves formed along an outer circumference so as to allow the protrusions to be inserted. Particularly, heat radiation holes are formed along the circumference of the connection hole at predetermined distance by connecting insertion parts of the protrusions to the insertion grooves of the hat part with a predetermined gap from an inner surface of the friction part. Also provided is a brake disc manufactured from heterogeneous materials having excellent durability.

### CROSS-REFERENCE TO RELATED APPLICATIONS

This application claims priority under 35 U.S.C. §119 to Korean Patent Application No. 10-2013-139775, filed on Nov. 18, 2013, in the Korean Intellectual Property Office, the disclosure of which is incorporated herein by reference in its entirety.

### TECHNICAL FIELD

The present invention relates to a brake disc. In particular, the brake disc may be manufactured from heterogeneous materials by connecting a friction part and a hat part which are formed of heterogeneous materials through a cast-bonding method. Disclosed is also a method for manufacturing the brake disc.

### BACKGROUND

In general, a brake disc of a vehicle refers to a device used to decelerate or stop the vehicle, and constitutes a braking system indispensible for the vehicle. The brake disc used for the braking system converts kinetic energy of the vehicle into heat energy by using frictional force generated by friction with a friction material to brake the vehicle.

In a brake disc of the related art, since a hat part attached to a hub and a friction part causing friction at the time of braking are made of the same material such as flake graphite grey cast iron, such brake disc has improved damping capacity, damping property, heat-radiating property and lubrication function.

heterogeneous materials In recent years, because of exhaustion of oil energy and climate change due to greenhouse gases, the global automobile industry has made efforts to develop technologies for improving fuel efficiency. Among tthose, a technology of reducing a weight of the vehicle without deteriorating the vehicle performance has been focused.

Indeed, reduction in weight at a lower side of the vehicle directly may affect the performance and fuel efficiency of the vehicle, and reduction in unsprung mass that is directly related to a wheel driving load may be efficient in improving the fuel efficiency.

Particularly, in order to reduce a weight of the brake disc, a brake disc including the friction part made of grey cast iron and the hat part made of aluminum has been used.

However, when the brake disc made of heterogeneous materials is used, and when a braking speed and a braking load are under a severe condition (for example, a temperature of a friction surface is increased to about 800° C.), cracks 30 may occur in the friction part due to a difference between thermal expansion coefficients of a friction part 10 made of grey cast iron and a hat part 20 made of an aluminum alloy (see FIG. 1).

### SUMMARY OF THE INVENTION

The present invention provides a brake disc manufactured from heterogeneous or different materials. The brake disc may have excellent durability under a severe condition by connecting a joining structure of a friction part and a hat part that have different thermal expansion coefficients. A method of manufacturing the brake disc is also provided.

In an exemplary embodiment, a brake disc manufactured from heterogeneous or distinct materials includes: a friction part in which a connection hole is formed in a center, protrusions and recesses are alternately repeated along a circumference of the connection hole, the recess has a shape curved in an opposite direction of the connection hole; and a hat part that is made of material different from that of the friction part, and has insertion grooves formed along an outer circumference so as to allow the protrusions to be inserted. In particular, heat radiation holes are formed along the circumference of the connection hole at predetermined distance by connecting insertion parts of the protrusions to the insertion grooves of the hat part with a predetermined gap from an inner surface of the friction part.

The insertion parts and the insertion grooves may be connected to each other through surface contact.

A thermal expansion coefficient of the hat part may be greater than a thermal expansion coefficient of the friction part.

The hat part may be made of an aluminum alloy, and the friction part may be made of cast iron.

A chamfer may be formed on any one or more surfaces of an upper surface and a lower surface of the protrusion at a predetermined angle. Particularly, when the hat part is made of an aluminum alloy and the friction part is made of cast iron, the chamfer may be formed such that a sum of angles is about 3 to 6 degrees.

Separation parts may be formed between the insertion parts and the insertion grooves at a predetermined distance, and the distance between the separation parts may be from about 0.3 to about 1 mm.

In another aspect, the present invention provides a method for manufacturing the brake disc using heterogeneous or distinct materials.

In an exemplary embodiment, the method includes steps of: a pre-heating step of processing a casted friction part including protrusions and recesses are alternately repeated along a circumference of a connection hole and heating the processed friction part; an attaching step of inserting the pre-heated friction part into a lower mold part of a mold provided with inserts for implementing heat radiation holes along the circumference of the connection hole at a predetermined distance; a casting step of connecting an upper mold to the lower mold and injecting molten metal which is a raw material of a hat part; and a finishing step of solidifying the casting, separating the solidified casting from the mold, and post-processing the separated casting.

The method may further include a pre-processing step of processing the friction part such that surface roughness is from about 6.3 to about 25 Ra, before the pre-heating step.

In the casting step, gravity casting or squeeze casting may be used, without limitation.

The friction part may be made of cast iron, and the hat part may be made of a molten aluminum alloy.

In the pre-heating step, the friction part may be heated at a temperature of about 300 to 400° C. for about 1 to 3 hours.

In the casting step, the molten aluminum alloy may be heated at a temperature of about 650 to 750° C. to be injected.

In the finishing step, the casting may be solidified for about 60 to 500 seconds.

According to various exemplary embodiments of the present invention, the heat radiation holes are formed between the friction part and the hat part that have different thermal expansion coefficients. As such, cracks occurring due to a difference between thermal expansion coefficients of difference materials under a severe condition of a highly elevated temperature may be prevented,.

Further, since the heat radiation holes are implemented at the brake disc, a weight of the brake disc may be further reduced compared to the conventional brake disc using heterogeneous materials, fuel efficiency and R&H (Ride & Handling) may be substantially improved.

Other aspects in the present invention are also disclosed infra.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a photographic view showing a test result after testing an exemplary brake disc manufactured from heterogeneous materials under a severe condition in the related art.

FIGS. 2 and 3 are respectively a perspective view and a top view of an exemplary brake disc manufactured from heterogeneous materials according to an exemplary embodiment of the present invention.

FIG. 4 is a perspective view of an exemplary friction part according to an exemplary embodiment of the present invention.

FIG. 5 is a perspective view of an exemplary hat part according to an exemplary embodiment of the present invention.

FIGS. 6 and 7 are cross-sectional views taken along line A-A′ in FIG. 2 and illustrate connected parts of an exemplary brake disc manufactured from heterogeneous materials according to an exemplary embodiment of the present invention.

FIGS. 8 to 10 are diagrams illustrating a chamfer angle of an exemplary brake disc manufactured from heterogeneous materials according to an exemplary embodiment of the present invention.

FIG. 11 is a perspective view of an exemplary lower mold part of an exemplary mold for manufacturing a break disc according to an exemplary embodiment of the present invention.

FIG. 12 is a perspective view illustrating an exemplary state where a friction part is attached to a lower mold part according to an exemplary embodiment of the present invention.

FIG. 13 is a photographic view showing a result after testing an exemplary brake disc manufactured from heterogeneous materials under a severe condition according to an exemplary embodiment of the present invention.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a brake disc manufactured from heterogeneous or distinct materials and a method of manufacturing the brake disc according to various exemplary embodiments of the present invention will be described with reference to the accompanying drawings.

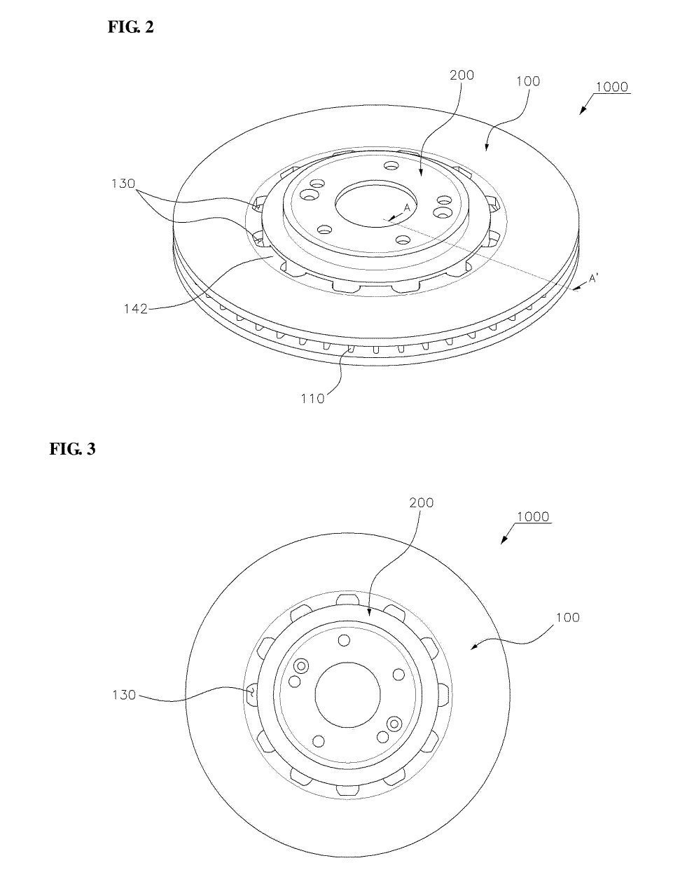

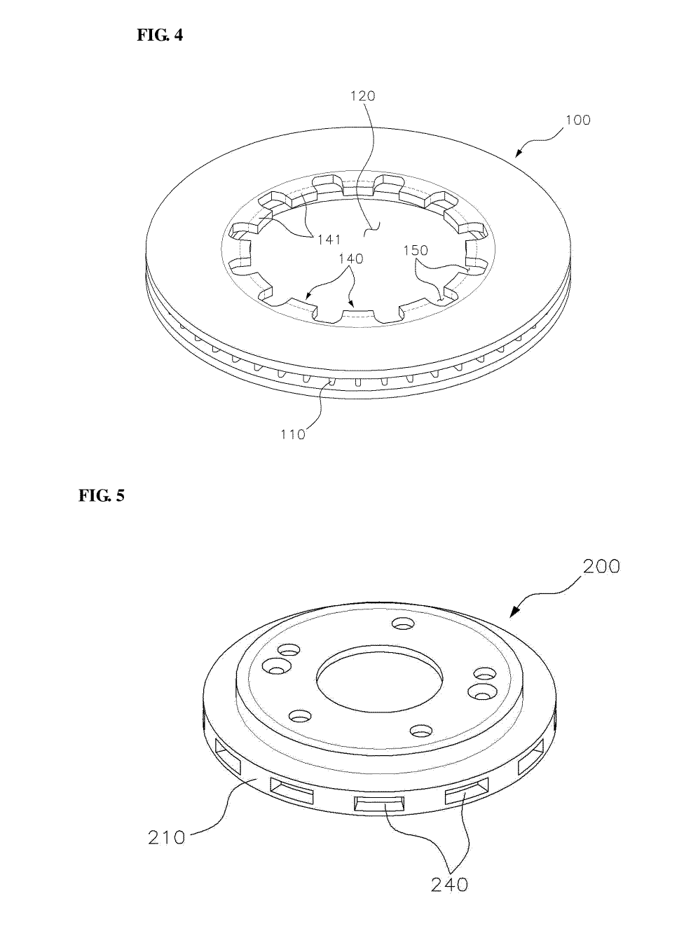

FIGS. 2 and 3 respectively illustrate a perspective view and a top view of an exemplary brake disc manufactured from heterogeneous materials according to an exemplary embodiment of the present invention. FIG. 4 is a perspective view of an exemplary friction part according to an exemplary embodiment of the present invention, and FIG. 5 is a perspective view of an exemplary hat part according to an exemplary embodiment of the present invention.

In an exemplary embodiment, as illustrated in the drawings, a brake disc 1000 manufactured from heterogeneous materials. The brake disc may include: a friction part 100 and a hat part 200. Particularly, the brake disc may include the friction part in which a connection hole 120 is positioned in a center as shown in FIG. 4, protrusions 140 and recesses 150 may be alternately repeated along a circumference of the connection hole 120, and the recess 150 may have a shape curved in an opposite direction of the connection hole. As shown in FIG. 5, the brake disc may also include the hat part 200 that is made of a different material from that of the friction part 100 and includes insertion grooves 240 into which the protrusions 140 are inserted along an outer circumference. Thus, insertion parts 141 of the protrusions 140 with a certain distance from an inner surface of the friction part 100 may be connected to the insertion grooves 240 of the hat part 200, and heat radiation holes 130 may be formed at a certain distance along the circumference of the connection hole 120. In certain exemplary embodiments, the insertion parts 141 and the insertion grooves 240 may be connected to each other through surface contact.

As such, the friction part may be connected to the hat part through the connection hole formed at the center. The protrusions and the recesses may be alternately repeated along an inner circumference of the connection hole, and a plurality of gap supports 110 are formed at the inside of the friction part to allow heat to be discharged through the gap supports 110.

It may be preferred that the hat part may be made of an aluminum alloy, and the friction part may be made of cast iron to reduce a weight of the brake disc. Since thermal expansion coefficients of the aluminum alloy and the cast iron are different from each other, the hat part having a greater thermal expansion coefficient may expand more to apply stress to the friction part under a severe condition such as a highly elevated temperature, thereby causing cracks. However, according to exemplary embodiments of the present invention, since a space is positioned where the hat part having a greater thermal expansion coefficient may expand toward the space of the heat radiation holes 130, the cracks may be prevented.

Since the heat radiation holes 130 are formed at a certain distance along the circumference of the connection hole, a plurality of bridges 142 may be formed and stress on braking torque may be dispersed to obtain mechanical strength.

In certain exemplary embodiments, a method of processing the recesses and the protrusions of the friction part may be, but not limited to, drill processing. Furthermore, since the recess may have a nearly circular shape curved in the opposite direction of the connection hole, the stress may be further dispersed than a rectangular hole.

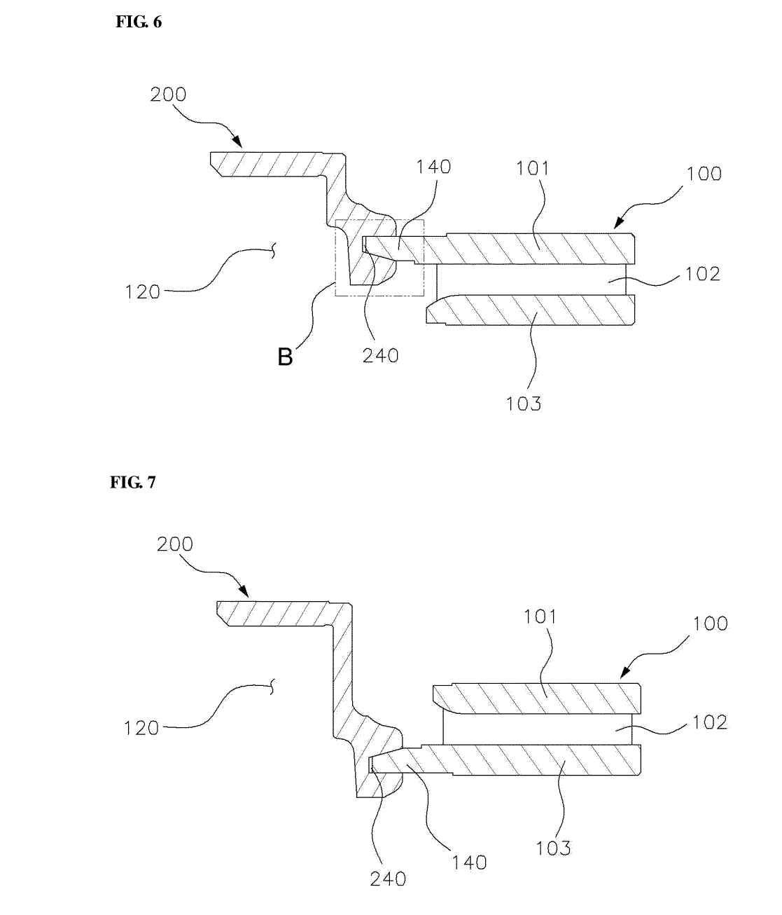

FIGS. 6 and 7 show cross-sectional views taken along line A-A′ in FIG. 2 and illustrate connected parts of an exemplary brake disc manufactured from heterogeneous materials. In certain exemplary embodiments, the friction part 100 may include an upper part 101, a lower part 103, and a rib 102 connecting the upper and lower parts. The upper part 101 may be connected to the hat part 200, or the lower part 103 may be connected to the hat part 200.

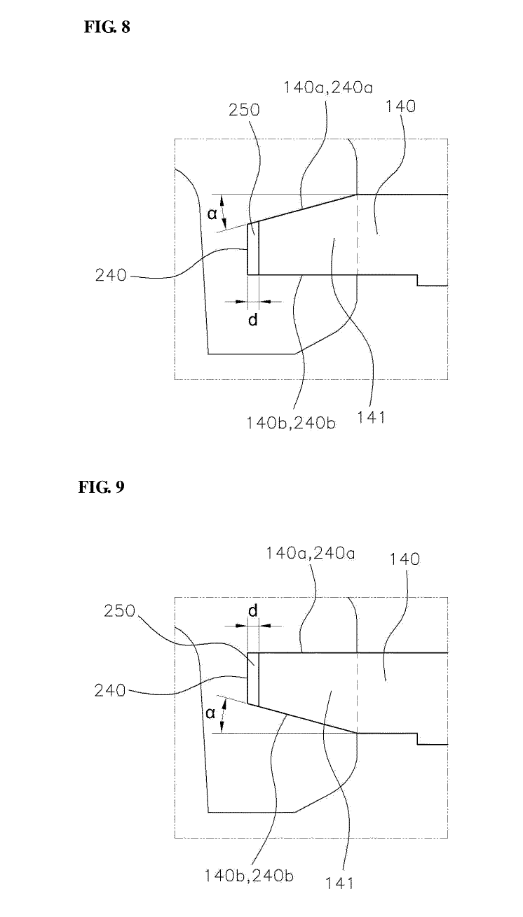

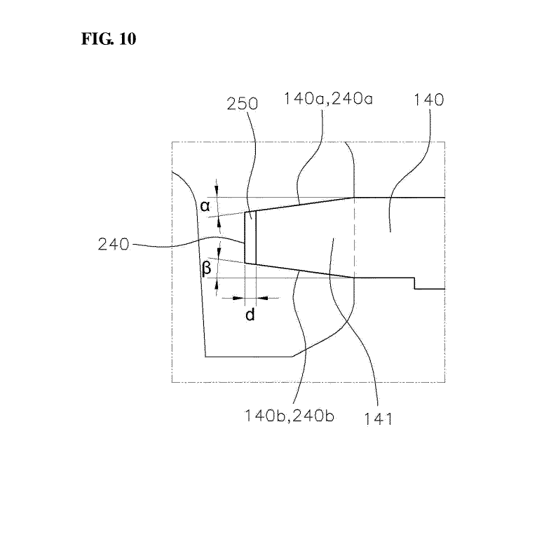

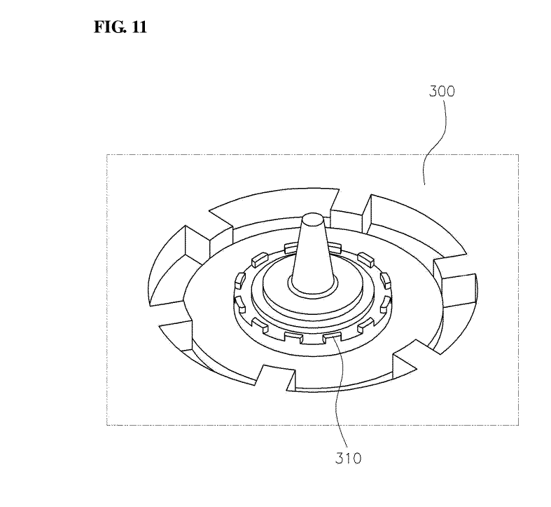

FIGS. 8 to 10 are diagrams illustrating a chamfer angle of an exemplary brake disc manufactured from heterogeneous materials. In an exemplary embodiment, an upper surface 140a and a lower surface 140b of the protrusion 140 of the friction part 100 may be in tight contact with an upper surface 240a and a lower surface 240bof the insertion groove 240, and a chamfer may be formed on any one or more surfaces of the upper surface 140a and the lower surface 140b of the protrusion 140 of the friction part 100 at a certain angle. In certain exemplary embodiments, when the chamfer is formed on any one surface, the chamfer may be formed at an angle α of about 3 to 6 degrees, and when the chamfers are formed on both the upper surface 140a and the lower surface 140b, the chamfers may be formed such that a sum (α+β) of angles may be from about 3 to about 6 degrees.

Due to a substantial difference between the thermal expansion coefficients of heterogeneous materials, particularly the thermal expansion coefficients of cast iron and aluminum, when these materials are connected to each other through casting, the aluminum alloy 200 may further contract. Accordingly, when the protrusion 140 of the friction part 100 is formed in a rectangular shape, since the friction part may not appropriately respond to the contraction of the hat part 200, the stress may be concentrated by braking torque, so that the friction part may be fractured. Accordingly, in an exemplary embodiment of the present invention, the hat part may be connected to the friction part to naturally surround the protrusions 140 by providing the chamfer at the protrusion 140 of the friction part 100, the hat part 200 contracts when the casting is solidified after casting. Thus, a defect when the friction part 100 and the hat part 200 are connected to each other may be minimized.

In certain exemplary embodiments, the angle of the chamfer may be calculated from a difference between thermal expansion coefficients of both materials, and the description thereof will be presented by referring to the following table.

TABLE 1

| | Thermal | Temperature | Thickness | Radius of | Thickness | Radius | | |
|---|---|---|---|---|---|---|---|---|
| | expansion | changing | of connected | connected | decreasing | decreasing | Chamfer | |
| Material | coefficient | amount | part | part | amount | amount | angle | |
| Aluminum | 2.15E−05 | 630 | 8 | 95 | 0.11 | 1.29 | | |
| alloy | | | | | | | | |
| Cast iron | 1.05E−05 | 320 | 8 | 95 | 0.03 | 0.32 | α | 4.8 |
| | | | | | 0.08 | 0.97 | | |

As seen in Table 1, when a molten temperature of the aluminum alloy is about 650° C. and a pre-heating temperature of the cast iron is about 340° C. , while the aluminum alloy and the cast iron are cooled to a room temperature of 20° C., thicknesses of the connection parts may decrease by thermal expansion coefficients. The aluminum alloy having greater thermal expansion coefficient may decrease more.

An example showing difference in decreasing amount between the aluminum and the cast iron is as follows. A thickness difference is 0.08, and a radius difference is 0.97. When an angle between the thickness and the radius is obtained using arctangent, the chamfer angle α is appropriately about 4.8 degrees. However, the chamfer angle may be changed depending on a temperature changing amount, and the chamfer angle may be about 3 to 6 degrees in the predetermined temperature section.

In certain exemplary embodiments, as shown in FIGS. 8-10, separation parts 250 may be formed between the insertion parts 141 of the protrusions 140 and the insertion grooves 240 at a certain distance, and the distance is may be about 0.3 to 1 mm. Moreover, due to a separation distance “d” in FIGS. 8 to 10, the separation part may have the separation distance and the slip distance between the friction part and the hat part may be secured during thermal expansion. As consequence, heat may not be transferred, so that braking characteristic may be maintained maintain for a long time.

In another aspect, a method for manufacturing the brake disc is provided.

In an exemplary embodiment, the method may include steps of: a pre-heating step of processing a casted friction part including protrusions and recesses which are alternately repeated along a circumference of a connection hole to heat the friction part; an attaching step of inserting the pre-heated friction part into a lower mold part of a mold which is provided with inserts for implementing heat radiation holes along the circumference of the connection hole at a predetermined distance; a casting step of connecting an upper mold part to the lower mold part and injecting molten metal which is a raw material of a hat part; and a finishing step of solidifying the casting, separating the casting from the mold, and post-processing the casting.

In certain exemplary embodiments, the method may further include a pre-processing step of processing the friction part such that the surface roughness thereof becomes about 6.3 to 25 Ra, before the pre-heating step. A unit Ra of the roughness as used herein refers to an arithmetic average roughness defined in ISO 4287:1997. Since the friction part has appropriate frictional force within the roughness range, the friction part and the hat part may have substantial frictional force through casting and slip each other. When the surface roughness is greater than the predetermined value of about 25 Ra, the friction part and the hat part may not slip and the stress may be concentrated. When the roughness is less than the predetermined value of about 6.3 Ra, although the chamfer may be formed, connecting force between the friction part and the hat part may be weak.

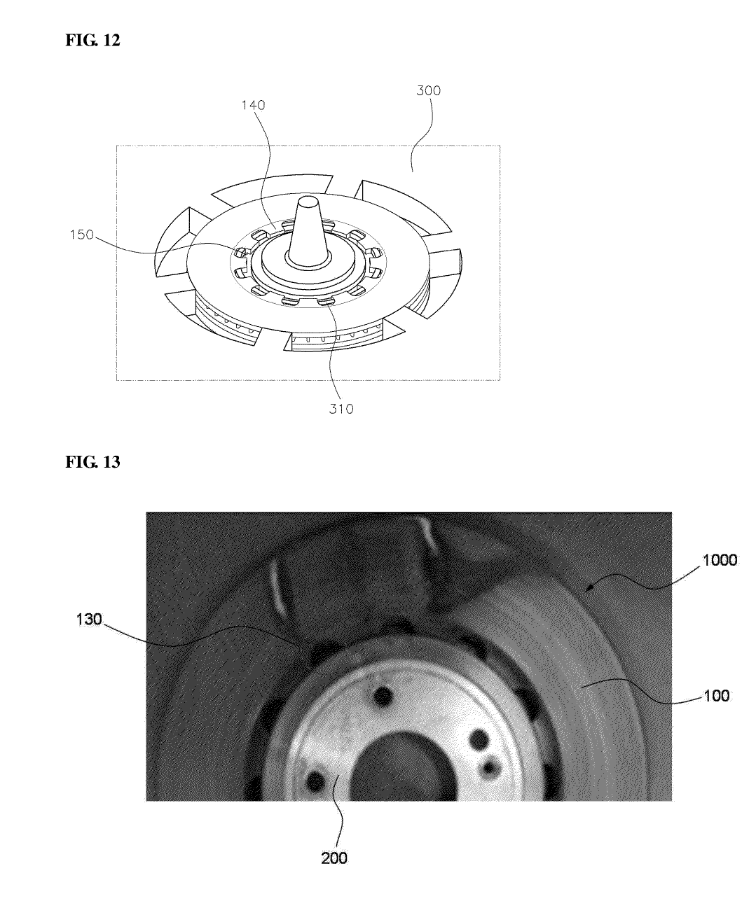

FIG. 11 is a perspective view of a lower mold part of a mold for manufacturing an exemplary break disc according to an exemplary embodiment of the present invention. FIG. 12 is a perspective view illustrating a state where an exemplary friction part is attached to the lower mold part according to an exemplary embodiment of the present invention. As illustrated in the drawings, a lower mold part 300 may be provided with inserts 310 for implementing the heat radiation holes along the circumference of the connection hole at a certain distance at the pre-heated friction part, and the friction part may be attached to the lower mold part such that the recesses 150 of the friction part are inserted into the inserts 310 of the lower mold part.

In certain exemplary embodiment, in the casting step, gravity casting or squeeze casting may be used, without limitation.

In yet certain exemplary embodiments, the friction part may be first casted using cast iron, and may be pre-processed to provide the aforementioned surface roughness. Subsequently, in the pre-heating step, the friction part may be heated at a temperature of about 300 to 400° C. for about 1 to 3 hours, and an annealing process may be performed on the material to remove the stress. In this state, the friction part may be joined to an aluminum alloy and casted to increase the connecting force.

In other certain exemplary embodiments, in the casting step, a molten aluminum alloy which is a raw material of the hat part may be heated at a temperature of about 650 to 750° C., and the molten aluminum alloy may be injected. In another certain exemplary embodiment, in the finishing step, the casting may be solidified for about 60 to 500 seconds and separated from the mold.

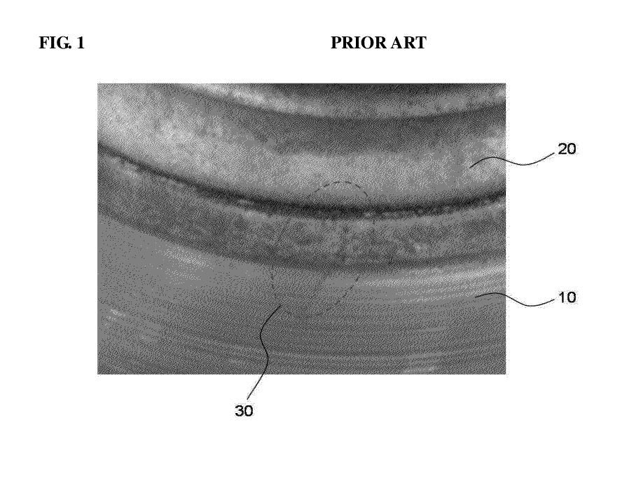

FIGS. 1 and 13 are photographic view illustrating results after testing an exemplary brake disc manufactured from heterogeneous materials in the related art and an exemplary brake disc manufactured from heterogeneous materials according to an exemplary embodiment the present invention. The test was performed under a severe condition, such as elevated temperature.

Particularly, since the brake discs may operate to a high-temperature and high-speed braking environment, a temperature of a friction surface may increase up to about 800° C. As shown in the test results in FIG. 1, cracks occur in the brake disc of the related art. However, since the brake disc 1000 in exemplary embodiments of present invention has the space where the hat part having a greater thermal expansion coefficient expand toward the space of the heat radiation holes 130, the cracks do not occur.

What is claimed is:

1. A brake disc comprising using different materialsheterogeneous materials, comprising:
a friction part in which a connection hole is formed in a center, protrusions and recesses are alternately repeated along a circumference of the connection hole, and the recess has a shape curved in an opposite direction of the connection hole; and
a hat part that is made of material different from that of the friction part, and has insertion grooves formed along an outer circumference so as to allow the protrusions to be inserted,
wherein heat radiation holes are formed along the circumference of the connection hole at predetermined distance by connecting insertion parts of the protrusions with a predetermined gap from an inner surface of the friction part to the insertion grooves of the hat part with a predetermined gap from an inner surface of the friction part.

2. The brake disc using different materials of claim 1, wherein the insertion parts and the insertion grooves are connected to each other through surface contact.

3. The brake disc using different materials of claim 1, wherein a thermal expansion coefficient of the hat part is greater than a thermal expansion coefficient of the friction part.

4. The brake disc using different materials of claim 3, wherein the hat part is made of an aluminum alloy, and the friction part is made of cast iron.

5. The brake disc using different materials of claim 1, wherein a chamfer is formed on any one or more surfaces of an upper surface and a lower surface of the protrusion at a predetermined angle.

6. The brake disc using different materials of claim 5, wherein a the chamfer is formed on any one or more surfaces of an upper surface and a lower surface of the protrusion at a predetermined angle, and the chamfer is formed such that a sum of the predetermined angles becomes is from about 3 to about 6 degrees.

7. The brake disc using different materials of claim 1, wherein separation parts are formed between the insertion parts and the insertion grooves at a predetermined distance.

8. The brake disc using different materials of claim 7, wherein the distance between the separation parts is from about 0.3 to about 1 mm.

9. A method for of manufacturing a brake disc comprising heterogenous or diferent materialsusing different materials, the method comprising:
a pre-heating step of processing a casted friction part such thatincluding protrusions and recesses are alternately repeated along a circumference of a connection hole and heating the processed friction part;
an attaching step of inserting the pre-heated friction part into a lower mold part of a mold provided with inserts for implementing heat radiation holes along the circumference of the connection hole at a predetermined distance;
a casting step of connecting an upper mold to the lower mold and injecting molten metal which is a raw material of a hat part; and
a finishing step of solidifying the casting, separating the solidified casting from the mold, and post-processing the separated casting.

10. The method for manufacturing a brake disc using different materials of claim 9, further comprising:
a pre-processing step of processing the friction part such that surface roughness becomes is from about 6.3 to about 25 Ra, before the pre-heating step.

11. The method for manufacturing a brake disc using different materials of claim 9, wherein in the casting step, gravity casting or squeeze casting is used.

12. The method for manufacturing a brake disc using different materials of claim 9, wherein the friction part is made of cast iron, and the hat part is made of a molten aluminum alloy.

13. The method for manufacturing a brake disc using different materials of claim 12, wherein in the pre-heating step, the friction part is heated at a temperature of about 300 to 400° C. for about 1 to 3 hours.

14. The method for manufacturing a brake disc using different materials of claim 12, wherein in the casting step, the molten aluminum alloy is heated at a temperature of about 650 to 750° C. to be injected.

15. The method for manufacturing a brake disc using different materials of claim 12, wherein in the finishing step, the casting is solidified for about 60 to 500 seconds.
